(19) United States
(12) Patent Application Publication
(10) Pub. No.: US 2019/0258119 A1
(43) Pub. Date: Aug. 22, 2019

(54) LIQUID CRYSTAL DISPLAY AND METHOD OF MANUFACTURING THE SAME

(71) Applicant: Samsung Display Co. Ltd., Yongin-si (KR)

(72) Inventors: Heung Shik PARK, Seoul (KR); Sang Gyun KIM, Hwaseong-si (KR); Hyun Ku AHN, Hwaseong-si (KR); Ki Chul SHIN, Seongnam-si (KR)

(21) Appl. No.: 16/398,751

(22) Filed: Apr. 30, 2019

Related U.S. Application Data
(62) Division of application No. 15/185,768, filed on Jun. 17, 2016.

(30) Foreign Application Priority Data
Dec. 23, 2015 (KR) 10-2015-0184645

(51) Int. Cl. G02F 1/1337

(52) U.S. Cl. CPC G02F 1/133711; G02F 1/134309; G02F 2001/133742; G02F 1/133707

(57) ABSTRACT

A liquid crystal display includes a display panel, an opposite display panel, a liquid crystal layer between the display panel and the opposite display panel. The display panel includes a first base substrate, a pretilt alignment stabilization layer including a polymer of a reactive mesogen, a first vertical alignment layer including a decomposition product of a polymerization initiator between the first base substrate and the pretilt alignment stabilization layer, and a pattern electrode between the first base substrate and the first vertical alignment layer. The opposite display panel includes a second base substrate, a patternless electrode on the second base substrate, and a second vertical alignment layer on the patternless electrode, which includes the decomposition product of the polymerization initiator. The liquid crystal layer includes a liquid crystal composition having negative dielectric anisotropy. A surface of the LCD that faces a viewer has a concave shaped curve.

This application is a divisional of U.S. patent application Ser. No. 15/185,768, filed on Jun. 17, 2016, which claims priority to Korean Patent Application No. 10-2015-0184645 filed on Dec. 23, 2015, in the Korean Intellectual Property Office, and all the benefits accruing therefrom under 35 U.S.C. § 119, the contents of each of which in their entirety are herein incorporated by reference.

### BACKGROUND

### 1. Field of the Invention

The present disclosure relates to a liquid crystal display (LCD) and a method of manufacturing the same.

### 2. Description of the Related Art

A liquid crystal display (LCD), which is one type of widely-used flat panel display, includes a liquid crystal module, which has a display panel, an opposite display panel, and a liquid crystal layer disposed between the display panel and the opposite display panel, a backlight unit, and the like. The LCD generates an electric field by applying a voltage to the field-generating electrodes and the electric field determines the alignment direction of liquid crystal molecules in the liquid crystal layer. The LCD displays an image by controlling the polarization of light incident thereupon.

In the meantime, the screen size of LCDs due to their use as the displays of television (TV) sets. However, as the size of an LCD increases, an image viewed at the front of the LCD may differ from an image viewed from the sides of the LCD.

To compensate for such a difference, an LCD may be bent into a curved shape such as a concave or convex shape. A curved LCD may be classified into a portrait type having a vertical length longer than the horizontal length and bent along a vertical direction, or a landscape type having a vertical length shorter than the horizontal length and bent along a horizontal direction.

### SUMMARY

Exemplary embodiments of the present disclosure provide a curved liquid crystal display (LCD) with improved transmittance and a method of manufacturing the same.

According to an exemplary embodiment, a liquid crystal display (LCD), includes a display panel, an opposite display panel, and a liquid crystal layer disposed between the display panel and the opposite display panel. The display panel includes a first base substrate, a pretilt alignment stabilization layer, a first vertical alignment layer, which is disposed between the first base substrate and the pretilt alignment stabilization layer, and a pattern electrode, which is disposed between the first base substrate and the first vertical alignment layer, where the pretilt alignment stabilization layer includes a polymer of a reactive mesogen, and the first vertical alignment layer comprises a decomposition product of a first polymerization initiator. The opposite display panel includes a second base substrate, a patternless electrode on the second base substrate, and a second vertical alignment layer on the patternless electrode, where the second vertical alignment layer includes a decomposition product of a second polymerization initiator. The liquid crystal layer includes a liquid crystal composition having negative dielectric anisotropy. A surface of the LCD that faces a viewer has a concave shaped curve.

According to another exemplary embodiment, a method of manufacturing an LCD includes, forming a first pre-vertical-alignment layer on a pattern electrode, the first pre-vertical alignment layer including a reactive mesogen and a first polymerization initiator; forming a second pre-vertical-alignment layer on a patternless electrode, the second pre-vertical alignment layer including a second polymerization initiator; forming a second vertical alignment layer by inactivating the second polymerization initiator and not inactivating the first polymerization initiator, wherein the second vertical alignment layer includes a decomposition product of the second polymerization initiator; forming a liquid crystal layer between the first pre-vertical alignment layer and the second vertical-alignment layer, the liquid crystal layer comprising a liquid crystal composition having negative dielectric anisotropy; eluting the reactive mesogens from the first pre-vertical alignment layer to the liquid crystal layer by applying a thermal treatment; forming a first vertical alignment layer and a pretilt alignment stabilization layer through an electric field exposure process, wherein the first vertical alignment layer comprises a decomposition product of the first polymerization initiator and the pretilt alignment stabilization layer comprises a polymer of the reactive mesogen; and fabricating a curved liquid crystal module after the forming the pretilt alignment stabilization layer such that a surface of the curved liquid crystal module which faces a viewer has a concave shaped curve.

According to another exemplary embodiment, a method of manufacturing an LCD, includes forming a first pre-vertical-alignment layer on a pattern electrode, the first pre-vertical alignment layer comprising a first polymerization initiator; forming a second pre-vertical-alignment layer on a patternless electrode, the second pre-vertical alignment layer comprising a second polymerization initiator; forming a second vertical alignment layer by inactivating the second polymerization initiator, not the first polymerization initiator, wherein the second vertical alignment layer comprises a decomposition product of the second polymerization initiator; forming a liquid crystal layer between the first pre-vertical alignment layer and the second vertical-alignment layer, the liquid crystal layer comprising a liquid crystal composition having negative dielectric anisotropy; forming a first vertical alignment layer and a pretilt alignment stabilization layer through electric field exposure process, wherein the first vertical alignment layer comprises a decomposition product of the first polymerization initiator and the pretilt alignment stabilization layer comprises a polymer of the reactive mesogen; and fabricating a curved liquid crystal module after the forming the pretilt alignment stabilization layer such that a surface of the curved liquid crystal module which faces a viewer has a concave shaped curve.

According to the exemplary embodiments, a curved LCD with improved transmittance may be provided.

Other features and aspects will be apparent from the following detailed description, the drawings, and the claims.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a schematic perspective view of a liquid crystal module according to an exemplary embodiment;

FIG. 2A is a schematic layout view of a display panel and an opposite display panel of the liquid crystal module of FIG. 1, and FIG. 2B is an enlarged view of the circled portion in FIG. 2A;

FIG. 3A is a schematic cross-sectional view of an area A of FIG. 2, taken along line III-III′ of FIG. 2, and FIGS. 3B and 3C are enlarged views of the respective circled portions in FIG. 3A;

FIG. 4 is a schematic cross-sectional view taken along line IV-IV′ of FIG. 2;

FIGS. 5A, 5B, 6A, 6B, 7A, 7B, and 8 through 10 are schematic views illustrating a method of manufacturing a liquid crystal display (LCD) according to an exemplary embodiment;

FIG. 11 is a schematic view illustrating states of alignment between an upper display panel and a lower display panel in a flat LCD (FLCD) and a curved LCD (CLCD) obtained from the FLCD, in which a pretilt alignment stabilization layer is formed on both upper and lower flat display panels;

FIGS. 12A, 12B, 13A, 13B, 13C, 14A, 14B, and 15 are schematic views illustrating a method of manufacturing an LCD according to another exemplary embodiment of the present disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Although the terms “first”, “second”, etc. may be used herein to describe various elements, these elements should not be limited by these terms. These terms may be used to distinguish one element from another element. Thus, a first element described in this application may be termed a second element without departing from teachings of one or more embodiments. The description of an element as a “first” element may not require or imply the presence of a second element or other elements. The terms “first”, “second”, etc. may also be used to differentiate different categories or sets of elements. For conciseness, the terms “first”, “second”, etc. may represent, for example, “first-category (or first-set)”, “second-category (or second-set)”, etc., respectively.

When a first element is referred to as being “on”, “connected to”, or “coupled to” a second element, the first element can be directly on, directly connected to, or directly coupled to the second element, or one or more intervening elements may be present. In contrast, when a first element is referred to as being “directly on”, “directly connected to”, or “directly coupled to” a second element, there are no intervening elements intentionally provided between the first element and the second element. Like numbers may refer to like elements in this application. The term “and/or” includes any and all combinations of one or more of the associated items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms “a”, “an”, and “the” are intended to include the plural forms as well, unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, integers, steps, operations, elements, and/or components, but do not s preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Embodiments are described herein with reference to cross-section illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of embodiments.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims,

The term “C_{A-B}”, as used herein, may denote a carbon number of A to B.

Exemplary embodiments will hereinafter be described with reference to the accompanying drawings.

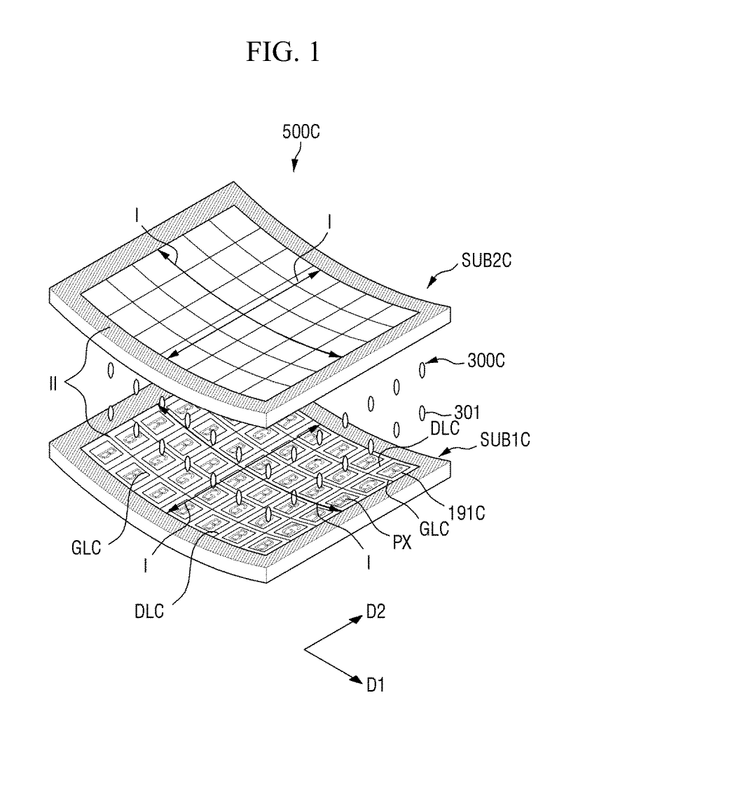

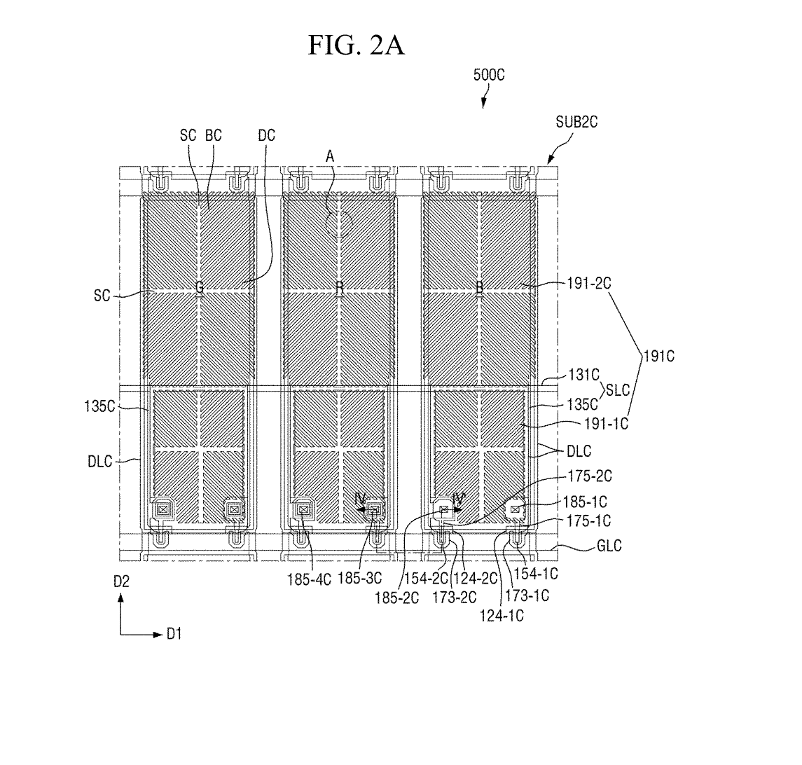

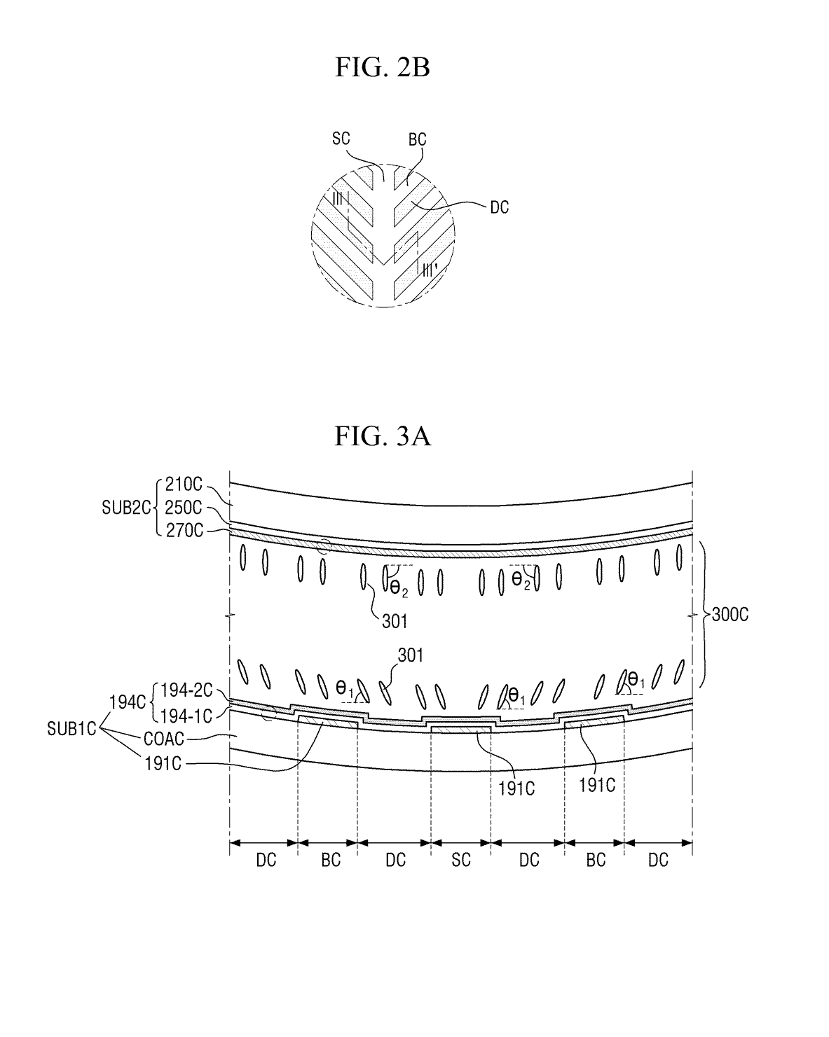

FIG. 1 is a schematic perspective view of a curved liquid crystal module according to an exemplary embodiment. FIG. 2A is a schematic layout view of a display panel and an opposite display panel of the curved liquid crystal module of FIG. 1, and FIG. 2B is an enlarged view of the circled portion A in FIG. 2A.

Referring to FIGS. 1 and 2, a liquid crystal display (LCD) according to an exemplary embodiment includes a curved liquid crystal module 500C, which includes a display panel SUB1C, an opposite display panel SUB2C, and a liquid crystal layer 300C. The display panel SUB1C and the opposite display panel SUB2C are spaced from each other while maintaining a predetermined cell gap therebetween, and the liquid crystal layer 300C is disposed between the display panel SUB1C and the opposite display panel SUB2C. The liquid crystal layer 300C may include liquid crystal molecules 301. The liquid crystal layer 300C may comprise a liquid crystal composition having negative dielectric anisotropy. The curved liquid crystal module 500C has a concave-shaped curve.

The curved liquid crystal module 500C includes a display area I and a non-display area II. The display area I is an area in which an image is viewed, and the non-display area II, which is positioned at the periphery of the display area I and surrounds the display area I, may be an area in which the image is not viewed.

The display panel SUB1C may include a plurality of gate lines GLC, which extend in a first direction D1, and a plurality of data lines DLC, which extend in a second direction D2 that is perpendicular to the first direction Dl. The gate lines GLC may be disposed not only in the display area I, but also may extend into the non-display area II, and gate pads (not illustrated) may be disposed in the non-display area II. In this case, the display panel SUB1C may include the gate pads in the non-display area II. The data lines DLC may be disposed not only in the display area I, but also may extend into the non-display area II, and data pads (not illustrated) may be disposed in the non-display area II. In this case, the display panel SUB1C may include the data pads in the non-display area II.

In the display area I, a plurality of pixels PX, which are defined by the gate lines GLC and the data lines DLC, may be disposed. The pixels PX may be arranged in the form of a matrix, and a plurality of pixel electrodes 191C may be respectively disposed in the pixels PX. In this case, in the display area I, the display panel SUB1C may include the pixels PX, which are arranged in the form of a matrix, and the pixel electrodes 191C.

In the non-display area II, a driver (not illustrated), which provides gate driving signals and data driving signals to the pixels PX, may be disposed. In this case, the display panel SUB1C may include the driver in the non-display area II.

Each of the pixel electrodes 191C may include sub-pixel electrodes 191-1C and 191-2C, which are spaced from each other. For example, each of the sub-pixel electrodes 191-1C and 191-2C may be generally rectangular in shape. Each of the sub-pixel electrodes 191-1C and 191-2C may be a slit pattern electrode, e.g., an electrode having slit patterns. More specifically, the slit patterns may include a cross-shaped stem SC, minute branches BC, which extend from the cross-shaped stem SC, and cutouts DC, which are disposed among the minute branches BC. The cross-shaped stem SC may be formed in the shape of a cross having a horizontal stem and a vertical stem that intersect each other, and the minute branches BC may extend radially from the cross-shaped stem portion SC in a direction of an angle of about 45° with respect to the cross-shaped stem portion SC. The opposing surfaces of every pair of adjacent slits DC with the horizontal stem interposed therebetween may be substantially parallel to each other along a horizontal direction. The opposing surfaces of every pair of adjacent slits DC with the vertical stem interposed therebetween may be substantially parallel to each other along a vertical direction.

Each of the gate lines GLC may include gate electrodes 124-1C and 124-2C, which extend from a corresponding gate line GLC to a corresponding pixel electrode 191C in the second direction D2. Each of the data lines DLC may include source electrodes 173-1C and 173-2C and drain electrodes 175-1C and 175-2C. The source electrodes 173-1C and 173-2C may protrude from a corresponding data line DLC and may be U-shaped. The drain electrodes 175-1C and 175-2C may be spaced from the source electrodes 173-1C and 173-2C, respectively.

Each of the pixel electrodes 191C may receive a data voltage via a switching device, for example, a thin-film transistor (TFT). The gate electrodes 124-1C and 124-2C, which are the s control terminals of the TFTs, may be electrically connected to the corresponding gate line GLC, the source electrodes 173-1C and 173-2C, which are the input terminals of the TFTs, may be electrically connected to the corresponding data line DLC via contact holes 185-1C, 185-2C, 185-3C, and 185-4C, and the drain electrodes 175-1C and 175-2C, which are the input terminals of the TFTs, may be electrically connected to a corresponding pixel electrode 191C. Semiconductor layers 154-1C and 154-2C may be disposed to overlap the gate electrodes 124-1C and 124-2C, respectively. The source electrodes 173-1C and 173-2C may be spaced from the drain electrodes 175-1C and 175-2C, respectively, with respect to the semiconductor layers 154-1C and 154-2C, respectively.

A sustain electrode line SLC may include a stem line 131C, which is disposed substantially in parallel to the gate lines GLC, and a plurality of branch lines 135C, which are branched off from the stem line 131C. The sustain electrode line SLC is optional and may not be present, and the shape and the location of the sustain electrode line SLC may vary.

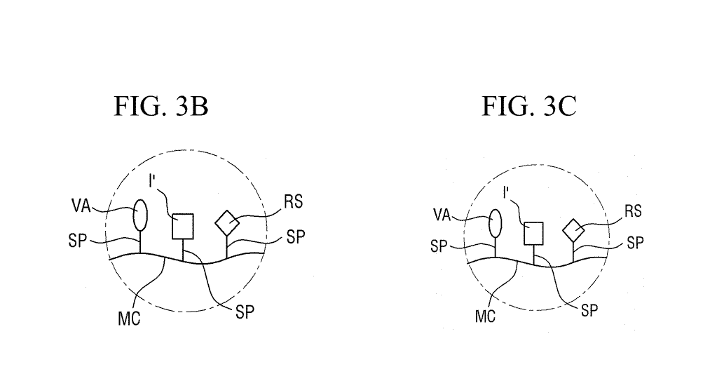

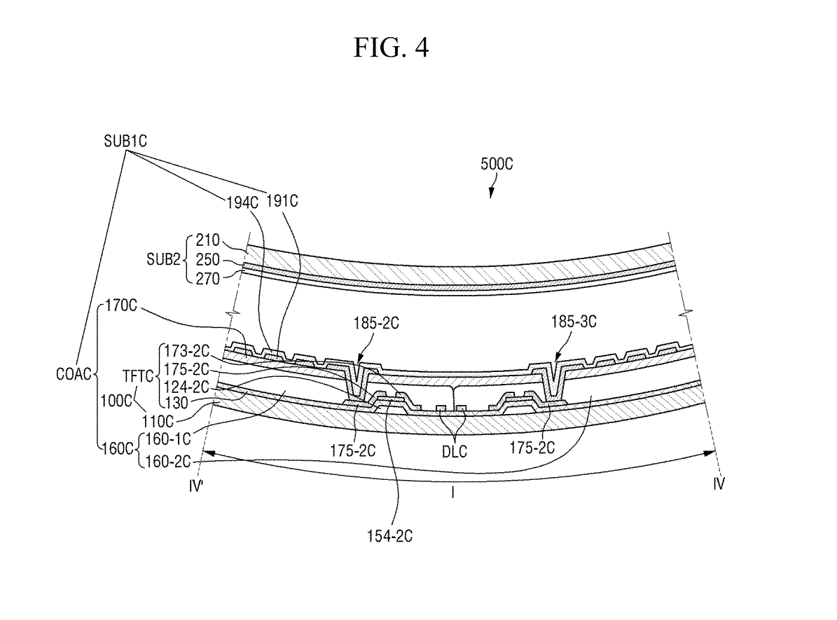

FIG. 3A is a schematic cross-sectional view of an area A of FIG. 2, taken along line III-III′ of FIG. 2. FIGS. 3B and 3C are enlarged views of the respective circled portions in FIG. 3A. FIG. 4 is a schematic cross-sectional view taken along line IV-IV′ of FIG. 2.

Referring to FIGS. 2 through 4, the display panel SUB1C may include a color filter on array substrate COAC, a pixel electrode 191C and a first liquid crystal alignment layer 194C. The color filter on array substrate COAC may have a structure in which a switching device array substrate 100C, a color filter 160C, and an organic layer 170C are stacked. The switching device array substrate 100C may have a structure including a first base substrate 110C and a switching device TFTC.

The first base substrate 110C may be provided as a transparent insulating substrate formed of glass or a transparent plastic material.

The switching device TFTC may be, for example, a TFT, and may include a gate electrode 124-2C, a gate insulating layer 130, the semiconductor layer 154-2C, an ohmic contact layer (not illustrated), the source electrode 173-2C, and the drain electrode 175-2C.

The gate electrode 124-2C, which is the control terminal of the switching device TFTC, may be disposed on the first base substrate 110C and may comprise a conductive material. The gate electrode 124-2C may be branched off from a gate line GLC. The gate insulating layer 130C may be disposed between the gate electrode 124-2C and the semiconductor layer 154-2C and may insulate the gate electrode 124-2C and the semiconductor layer 154-2C from each other. The semiconductor layer 154-2C, which is the channel layer of the switching device TFTC, may be disposed on the gate insulating layer 130C. The source electrode 173-2C and the drain electrode 175-2C may be spaced apart from each other over the semiconductor layer 154-2C and may comprise a conductive material. The source electrode 173-2C and the drain electrode 175-2C may be branched off from a data line DLC. The ohmic contact layer may be formed between the source electrode 173-2C and the semiconductor layer 154-2C and between the drain electrode 175-2C and the semiconductor layer 154-2C.

The color filter 160C may be formed on the switching device array substrate 100C. The color filter 160C may be formed on the first base substrate 110C and the switching device TFTC. The color filter 160C may be formed in an area corresponding to each pixel in the display area I, and may include a first color filter 160-1C and a second color filter 160-2C. For example, the first color filter 160-1C and the second color filter 160-2C may be color filters realizing different colors, and each of the first color filter 160-1C and the second color filter 160-2C may be independently one of a red color filter R, a green color filter G, and a blue color filter B. The first color filter 160-1C and the second color filter 160-2C may be alternately arranged.

An organic layer 170C, which is formed of an organic material, may be formed on the color filter 160C. The organic layer 170C may or may not be present.

The pixel electrode 191C may be formed on the color filter on array substrate COA. The pixel electrode 191C may be electrically connected to the drain electrode 175-2C via contact holes 185-2C and 185-3C, which penetrate the color filter 160C and the organic layer 170C. The pixel electrode 191C may be formed of indium tin oxide (ITO), indium zinc oxide (IZO), indium oxide, zinc oxide, tin oxide, gallium oxide, titanium oxide, aluminum (Al), silver (Ag), platinum (Pt), chromium (Cr), molybdenum (Mo), tantalum (Ta), niobium (Nb), zinc (Zn), magnesium (Mg), or an alloy or deposition layer thereof. The pixel electrode 191C may be a pattern electrode having a protrusion pattern, a slit pattern, or both a protrusion pattern and a slit pattern. For example, the pixel electrode 191C may be a pattern electrode having the slit patterns described above. The pixel electrode 191C may form an electric field together with a common electrode 250C and may thus control the alignment direction of the liquid crystal molecules 301 of the liquid crystal layer 300C, which is disposed between the pixel electrode 191C and the common electrode 250C.

The first liquid crystal alignment layer 194C may be formed on the pixel electrode 191C and the color filter on array substrate COAC. The first liquid crystal alignment layer 194C includes a first vertical alignment layer 194-1C and a pretilt alignment stabilization layer 194-2C. The first vertical alignment layer 194-1C may align the liquid crystal molecules 301 to be substantially vertical with respect to the display panel SUB1C at an initial state in which an electric field is not yet applied to the curved liquid crystal module 500C.

As illustrated in FIG. 3B, the first vertical alignment layer 194-1C may comprise a branched polymer having a main chain MC, a first vertical alignment group VA, a first radical scavenger RS (or a decomposition product thereof), and a decomposition product I′ of a first polymerization initiator I, and the first vertical alignment group VA. The first radical scavenger RS (or a decomposition product thereof) and the decomposition product I′ may be bonded to the main chain MC via spacer groups SP. The first radical scavenger RS (or a decomposition product thereof) may or may not be present. The main chain MC may be, for example, a polyimide-based polymer having an imide group as a repeating unit.

The first vertical alignment group VA may be, for example, a C₁₋₈ alkyl group, a hydrocarbon derivative having a terminal substituted with a C₁₋₈ alkyl group, a hydrocarbon derivative having a terminal substituted with a C₃₋₆ cycloalkyl group, or a hydrocarbon derivative having a terminal substituted with an aromatic hydrocarbon. The first vertical alignment group VA may align the liquid crystal molecules 301 to be substantially vertical with respect to the display panel SUB1C in the initial state in which an electric field is not yet applied to the curved liquid crystal module 500C.

The first radical scavenger RS may capture cation impurities present in the liquid crystal layer 300C and may thus improve the voltage holding ratio (VHR) of the LCD according to the present exemplary embodiment, thereby improving image sticking. The first radical scavenger RS may be, for example, nitrobenzene, butylated hydroxyl toluene (BHT), or 2,2-diphenyl-1-picryl hydrazyl (DPPH). A presence of a decomposition product of the first radical scavenger RS may indicate a product of the reaction of the first radical scavenger RS with free radicals has been formed.

The decomposition product I′ may indicate a product obtained when a radical polymerization reaction initiated by the first polymerization initiator I is complete and may be a compound that no longer generates free radicals. The first polymerization initiator I may be at least one selected from, for example, acetophenone, benzoin, benzophenone, dimethoxy acetophenone, phenylethanone, thioxanthone, 2-hydroxy-2-methyl-1-phenylpropan-1-one, 4-(2-hydroxyethoxy)phenyl-(2-hydroxy)-2-propyl ketone, 1-hydroxycyclohexyl phenyl ketone, methyl-o-benzoylbenzoate, 4-phenyl benzophenone, 4-benzoyl-4′-methyl-diphenyl sulfide, (4-benzoyl-benzyl) trimethylammonium chloride, bis(2,4,6-trimethylbenzoyl)-phenyl phosphine oxide, diphenyl(2,4,6-trimethylbenzoyl)phosphine oxide, 2-hydroxy methyl propionic nitrile, 2,2′-{azobis(2-methyl-N-[1,1′-bis(hydroxymethyl)-2-hydroxyethyl) propionamide], acrylate[(2-methoxy-2-phenyl-2-benzoyl)ethyl]ester, phenyl 2-acryloyloxy-2-propyl ketone, phenyl 2-methacryloyloxy-2-propyl ketone, 4-isopropylphenyl 2-acryloyloxy-2-propyl ketone, 4-chlorophenyl 2-acryloyloxy-2-propyl ketone, 4-dodecylphenyl 2-acryloyloxy-2-propyl ketone, 4-methoxyphenyl 2-acryloyloxy-2-propyl ketone, 4-acryloyloxyphenyl 2-hydroxy-2-propyl ketone, 4-methacryloyloxy 2-hydroxy-2-propyl ketone, 4-(2-acryloyloxyethoxy)-phenyl 2-hydroxy-2-propyl ketone, 4-(2-acryloyloxydiethoxy)-phenyl 2-hydroxy-2-propyl ketone, 4-(2-acryloyloxyethoxy)-benzoin, 4-(2-acryloyloxyethylthio)-phenyl 2-hydroxy-2-propyl ketone, 4-N,N′-bis-(2-acryloyloxyethyl)-aminophenyl 2-hydroxy-2-propyl ketone, 4-acryloyloxyphenyl 2-acryloyloxy-2-propyl ketone, 4-methacryloyloxyphenyl 2-meythacryloyloxy-2-propyl ketone, 4-(2-acryloyloxyethoxy)-phenyl 2-acryloyloxy-2-propyl ketone, 4-(2-acryloyloxydiethoxy)-phenyl 2-acryloyloxy-2-propyl ketone, dibenzyl ketone, benzoin alkyl ether, benzoin methyl ether, benzoin ethyl ether, benzoin isopropyl ether, benzoin isobutyl ether, dialkyl acetophenone, hydroxyl alkylketone, phenyl glyoxylate, benzyl dimethyl ketal, acyl phosphine, and α-aminoketone.

The pretilt alignment stabilization layer 194-2C may include a polymer of a reactive mesogen. The reactive mesogen may include a compound represented by Formula I below. The pretilt alignment stabilization layer 194-2C may stabilize or fix in place a pretilt alignment state of the liquid crystal molecules 301 that are tilted at a predetermined pretilt angle with respect to the display panel SUB1C at the initial state in which an electric field is not yet applied to the curved liquid crystal module 500C. The pretilt alignment state is a state in which the alignment angle of the liquid crystal molecules 301 is different from, by as much as the pretilt angle, a state in which the liquid crystal molecules 301 are aligned substantially vertically with respect to the display panel SUB1C.

P1-SP1-A1-(A2)m-SP2-P2 Formula I

In Formula 1, where each of P1 and P2 is a polymerizable terminal group and may be, for example, a (meth)acrylate group, a vinyl group, a vinyloxy group, or an epoxy group; SP1 is a spacer group connecting P1 and A1 and may be, for example, a C₁₋₁₂ alkyl group or a C₁₋₁₂ alkoxy group; SP2 is a spacer group connecting P2 and SP2 and may be, for example, a C₁₋₁₂ alkylene group or a C₁₋₁₂ alkyleneoxy group; each of A1 and A2 is independently a mesogen structure and may be, for example, cyclohexylene, biphenylene (represented by -Phe-Phe-, where -Phe- denotes a phenylene group), terphenylene (represented by -Phe-Phe-Phe-, where -Phe- denotes a phenylene group), naphthalene, or thiophene, at least one hydrogen atom of which may be independently substituted with halogen, —OCH₃, or a C₁₋₆ alkyl group; and m may be 1 to 3.

For example, the reactive mesogens may comprise at least one of compounds represented by Formulas II and III:

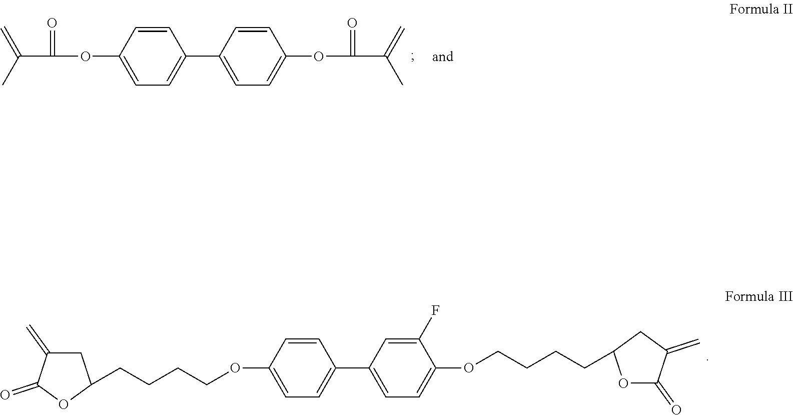 [SMILES: C=C(C)C(=O)Oc1ccc(-c2ccc(OC(=O)C(=C)C)cc2)cc1 ; ";" ; "and" ; C=C1CC(CCCCOc2ccc(-c3ccc(OCCCCC4CC(=C)C(=O)O4)c(F)c3)cc2)OC1=O ; "."]

Although not specifically illustrated, the display panel SUB1C may also include a light-shielding pattern (not illustrated). The light shielding pattern may be disposed between the pattern electrode 191C and the first liquid crystal alignment layer 194C, but the location of the light-shielding pattern is not particularly limited as long as the light-shielding pattern is disposed over, and overlaps, opaque devices such as, for example, the switching device TFTC, a gate line (not illustrated), and the data line DLC. The light-shielding pattern may also be referred to as a black matrix.

The opposite display panel SUB2C may include a second base substrate 210C, the common electrode 250C, and a second vertical alignment layer 270C. In an exemplary embodiment, a surface of the LCD that faces a viewer may have a concave shaped curve and may be provided on the opposite display panel SUB2C.

The second base substrate 210C may be provided as a transparent insulating substrate formed of glass or a transparent plastic material.

The common electrode 250C may be disposed on the second base substrate 210C. The common electrode 250C may be a patternless electrode which does not have a slit pattern or a protrusion pattern. The curved liquid crystal module 500C includes a pattern electrode only on the display panel SUB1C and a patternless electrode on the opposite display panel SUB2C, and controls the alignment of the liquid crystal molecules 301 using the pattern electrode. The common electrode 250C may be formed of ITO, IZO, indium oxide, zinc oxide, tin oxide, gallium oxide, titanium oxide, Al, Ag, Pt, Cr, Mo, Ta, Nb, Zn, Mg, or an alloy or deposition layer thereof. The common electrode 250C may be formed to cover the entire display area I. That is, the common electrode 250C may be integrally formed on the entire surface of the display area I regardless of each pixel.

The second vertical alignment layer 270C may be disposed on the common electrode 250C. The second vertical alignment layer 270C may align the liquid crystal molecules 301 substantially vertically with respect to the display panel SUB2C at the initial state in which an electric field is not yet applied to the LCD according to the present exemplary embodiment. The second vertical alignment layer 270C may comprise a branched polymer having a main chain MC, a second vertical alignment group VA, a second radical scavenger RS (or a decomposition product thereof), and a decomposition product I′ of a second polymerization initiator I, and the second vertical alignment group VA, the second radical scavenger RS (or a decomposition product thereof), and the decomposition product I′ may be bonded to the main chain MC via spacer groups SP. The second radical scavenger RS (or a decomposition product thereof) may or may not be provided. The main chain MC may be, for example, a polyimide-based polymer having an imide group as the repeating unit.

The second vertical alignment group VA, the second radical scavenger RS, and the decomposition product I′ are substantially identical to the first vertical alignment group VA, the first radical scavenger RS, and the decomposition product I′, respectively, and thus, detailed descriptions thereof are omitted.

Although not specifically illustrated, the LCD according to the present exemplary embodiment may also include a backlight assembly (not illustrated), which is disposed at the rear of the display panel SUB 1C and provides light to the liquid crystal layer 300C.

The backlight assembly may include, for example, a light guide plate (LGP), a light source unit, a reflective member, and one or more optical sheets.

The LGP, which changes the path of light generated by the light source unit in order to direct the light toward the liquid crystal layer 300, may include an incidence surface, which is provided to receive the light generated by the light source unit, and an emission surface, which faces the liquid crystal layer 300. The LGP may be formed of a material having a uniform refractive index, such as polymethyl methacrylate (PMMA) or polycarbonate (PC), but is not limited thereto.

Light incident upon one or both sides of the LGP may have an angle of incidence smaller than the critical angle of the LGP, and may thus enter the LGP. On the other hand, light incident upon the top or bottom surface of the LGP may have an angle of incidence greater than the critical angle of the LGP, and may thus be evenly distributed throughout the LGP instead of being emitted out of the LGP.

A diffusion pattern may be formed on at least one of the top and bottom surfaces of the LGP, for example, on the bottom surface of the LGP that is opposite to the emission surface of the LGP, in order for guided light to be emitted upward. More specifically, in order for light transmitted within the LGP to be emitted upward, the diffusion pattern may be printed on one surface of the LGP using ink, but is not limited thereto. For example, an array of fine grooves or protrusions may be formed on the LGP as the diffusion pattern, or various other modifications may be made to the diffusion pattern without departing from the scope of the present disclosure.

The reflective member (not illustrated) may be additionally provided between the LGP and a lower receiving member (not illustrated). The reflective member reflects light emitted from the bottom surface of the LGP, which is opposite to, and faces, the emission surface of the LGP, and thus the reflective member applies the light back to the LGP. The reflective member may be formed as a film, but is not limited thereto.

The light source unit may be disposed to face the incidence surface of the LGP. The number of light source units may be appropriately varied. For example, only one light source unit may be positioned on one side of the LGP. Alternatively, three or more light source units may be positioned to correspond to three or more sides of the LGP. Still alternatively, a plurality of light source units may be positioned to correspond to only one side of the LGP. The backlight unit has been described above and may be, for example, a side light-type backlight unit in which one or more light source units are provided on one or more sides of an LGP, but is not limited thereto. That is, a direct-type backlight unit or another light source device, such as a surface-type light source device, may also be used.

The light source unit may include a white light-emitting diode (LED), which emits white light, or a plurality of LEDs, which emit red (R) light, green (G) light and blue (B) light. In response to the light source unit including a plurality of LEDs emitting R light, G light, and B light, white light may be realized by turning on all the LEDs to mix the R light, G light, and B light together.

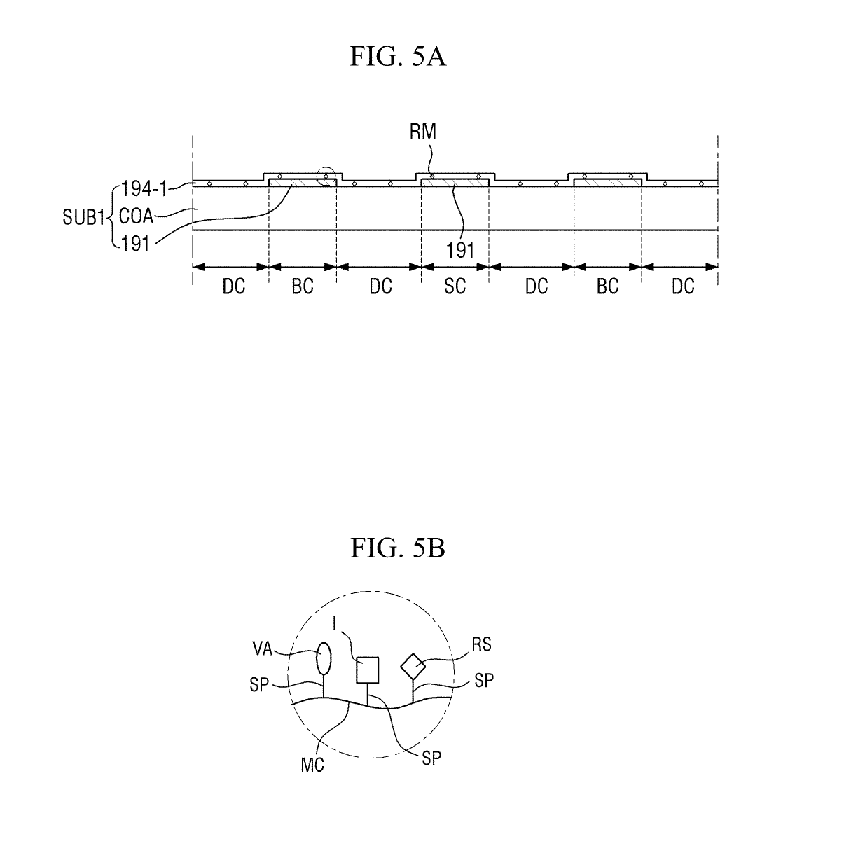

FIGS. 5A, 5B, 6A, 6B, 7A, 7B, and 8 through 10 are schematic views illustrating a method of manufacturing an LCD according to an exemplary embodiment of the present disclosure.

FIG. 5A illustrates a method of manufacturing a display panel SUB1, and FIG. 5B is an enlarged view of the circled portion in FIG. 5A. Referring to FIG. 5A, the display panel SUB1 may be fabricated by forming a pixel electrode 191 on a color filter on array substrate COA, applying a first liquid crystal vertical alignment agent comprising reactive mesogens RM onto the pixel electrode 191, and performing thermal treatment to form a first pre-vertical-alignment layer 194-1. Referring to FIG. 5B, the first pre-vertical-alignment layer 194-1 may include a branched polymer having a main chain MC, a first vertical alignment group VA, a first polymerization initiator I, and a first radical scavenger RS.

For example, the first pre-vertical-alignment layer 194-1 may include a compound represented by Formula A:

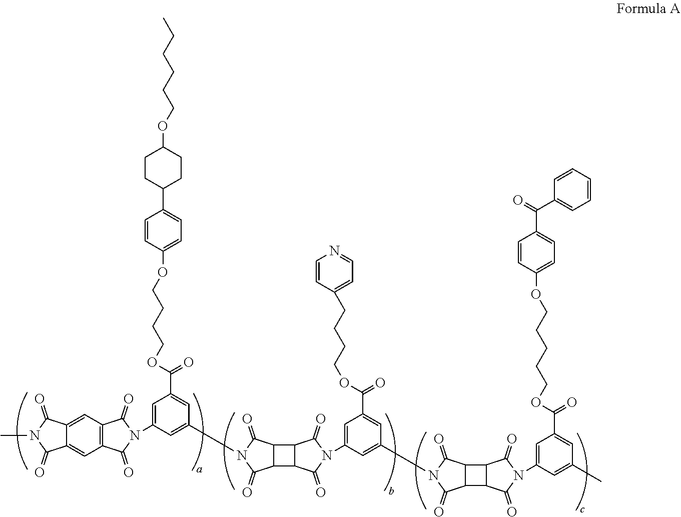

Where a, b, and c are a natural number of 1 to 100.

The first radical scavenger RS may or may not be provided. When present the first radical scavenger RS may be contained in the first pre-vertical-alignment layer 194-1 to enhance the VHR of an LCD.

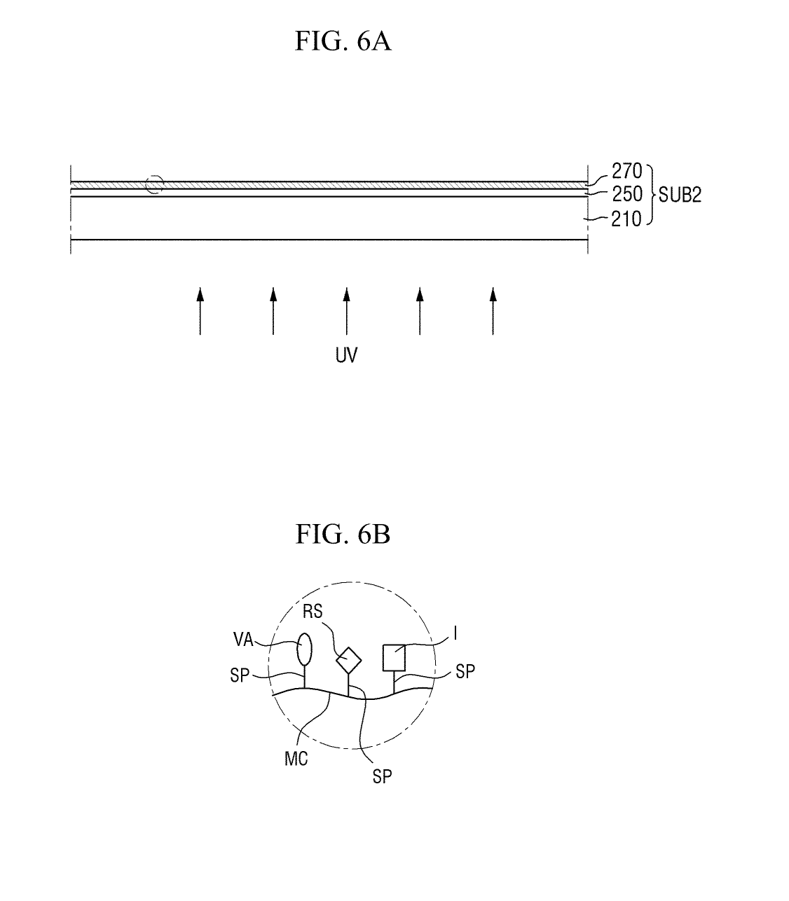

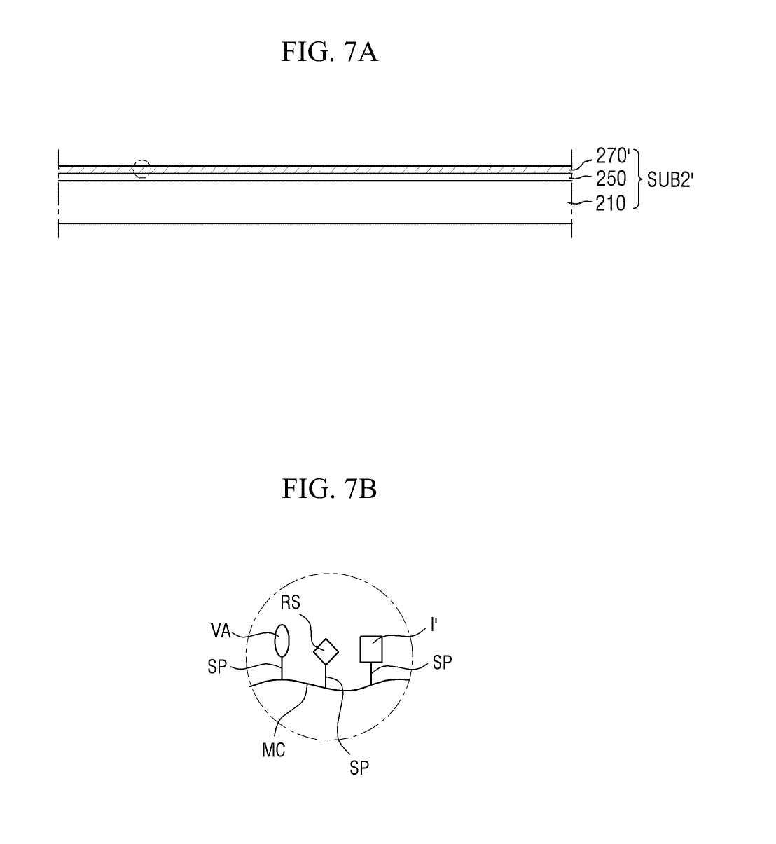

FIG. 6A illustrates a method of manufacturing an opposite display panel SUB2 and FIG. 6B is an enlarged view of the circled portion in FIG. 6A. FIG. 7A illustrates an opposite display panel SUB2′ obtained by applying ultraviolet (UV) light to the opposite display panel SUB2 of FIG. 6A, while FIG. 7B is an enlarged view of the circled portion in FIG. 7A.

Referring to FIGS. 6A, 6B, 7A, and 7B, the opposite display panel SUB2 may be fabricated by forming a common electrode 250 on the second base substrate 210, applying a second liquid crystal vertical alignment agent onto the common electrode 250, and performing thermal treatment so as to form a second pre-vertical-alignment layer 270. The second pre-vertical-alignment layer 270 may comprise a branched polymer having a main chain MC, a second vertical alignment group VA, a second polymerization initiator I, and a second radical scavenger RS. For example, the second pre-vertical-alignment layer 270 may comprise a compound represented by Formula A above.

By applying UV light to the opposite display panel SUB2, the radical polymerization reaction initiation function (e.g. the ability to initiate a radical polymerization reaction) of the second polymerization initiator I may be eliminated. That is, by applying UV light to the opposite display panel SUB2, free radicals may be produced from the second polymerization initiator I, and the chain growth and termination of the free radicals may be induced so as to inactivate the radical polymerization reaction initiation function of the second polymerization initiator I. After exposure to UV light, the second polymerization initiator I may be transformed into a decomposition product I′. That is, the second pre-vertical-alignment layer 270 may be transformed into a second vertical alignment layer 270′ in which a radical polymerization reaction initiation function has been eliminated therefrom, and the opposite display panel SUB2 may be transformed into the optical display panel SUB2′.

The second radical scavenger RS may or may not be provided. When present, the second pre-vertical-alignment layer 270 may include the second radical scavenger RS to promote the termination of the free radicals.

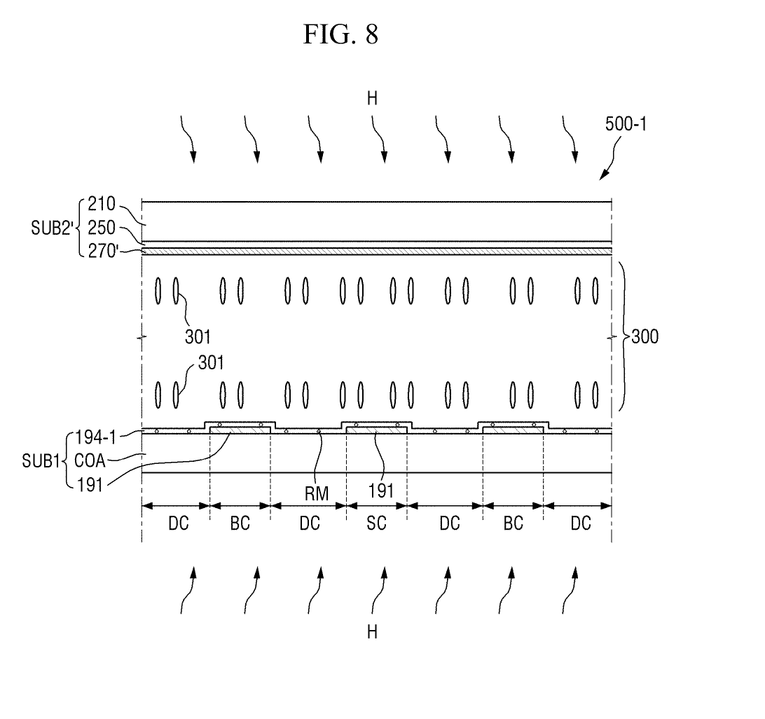

FIG. 8 illustrates a method of manufacturing a liquid crystal panel 500-1 by injecting or dropping a liquid crystal composition between the display panel SUB1 and the optical display panel SUB2′ so as to form a liquid crystal layer 300. The liquid crystal composition includes liquid crystal molecules 301 and has negative dielectric anisotropy. The method further includes eluting the reactive mesogen RM from the first pre-vertical-alignment layer 194-1 to the liquid crystal layer 300 by performing thermal treatment H on the liquid crystal display panel 500-1. The temperature and time for the thermal treatment may be varied based upon the type of reactive mesogen, and for example, may include heating at a temperature of about 220° C. to about 240° C., for about 10 minutes to about 30 minutes. The liquid crystal molecules 301 may be aligned substantially vertically with respect to the display panel SUB1 and the opposite display panel SUB2′.

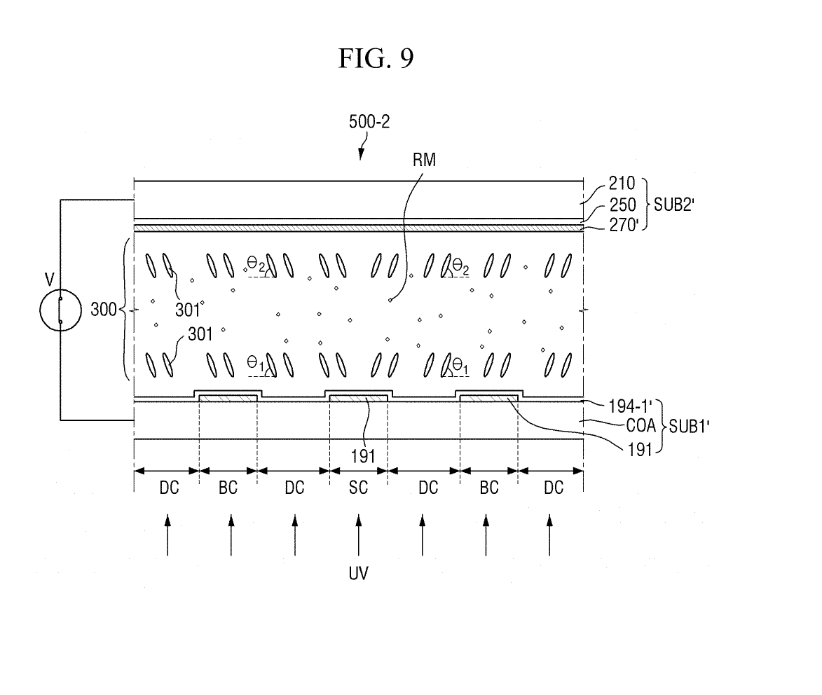

FIG. 9 illustrates performing an electric field V exposure process on a liquid crystal panel 500-2 after the elution of the reactive mesogen RM from the first pre-vertical alignment layer to the liquid crystal layer 300. The liquid crystal molecules 301 may be thus obliquely aligned to have pretilt angles θ₁ and θ₂ with respect to a display panel SUB1′ and the opposite display panel SUB2′, respectively. The pretilt angle θ₁, which is the pretilt angle of liquid crystal molecules 301 aligned on the display panel SUB1′, may be substantially the same as the pretilt angle θ₂, which is the pretilt angle of liquid crystal molecules 301 aligned on the opposite display panel SUB2′. The display panel SUB1′ does not include any reactive mesogen RM, or alternatively, may include the first pre-vertical-alignment layer 194-1′, which comprises only a small amount of reactive mesogen RM.

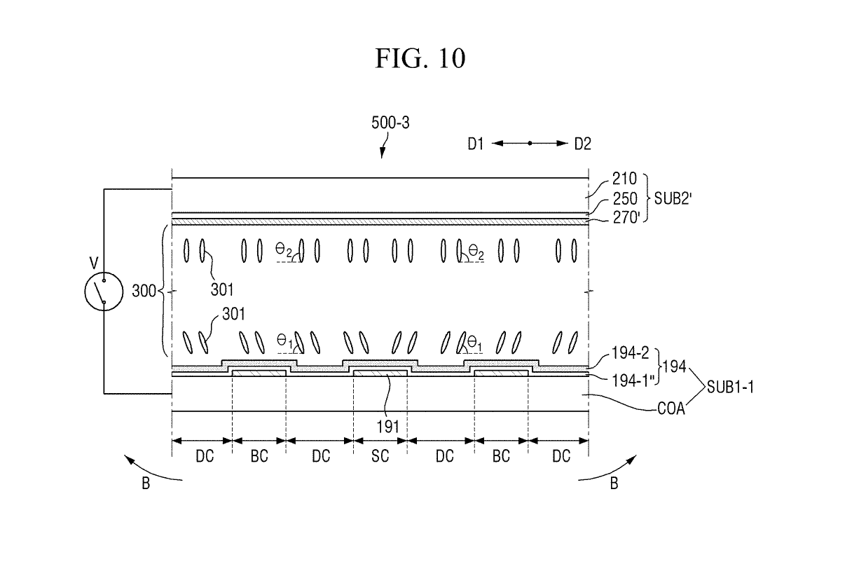

Referring to FIG. 10, a pretilt alignment stabilization layer 194-2 is selectively formed only on a first vertical alignment layer 194-1″, and is not formed on a second vertical alignment layer 270′. A first liquid crystal alignment layer 194 includes the first vertical alignment layer 194-1″ and the pretilt alignment stabilization layer 194-2.

Referring to FIGS. 6 through 10, since the second vertical alignment layer 270′ with a radical polymerization reaction initiation function eliminated therefrom is unable to initiate the radical polymerization reaction of the reactive mesogens RM during the electric field exposure process, the radical polymerization reaction of the reactive mesogen RM may selectively occur only on the first pre-vertical alignment layer 194-1′ and not on the second vertical alignment layer 270′. As a result of the electric field exposure process, the first pre-vertical-alignment layer 194-1′ is transformed into a first vertical alignment layer 194-1″, and any remaining decomposition product I′ of the first polymerization initiator I from the production of free radicals may be left behind on the first vertical alignment layer 194-1″. The electric field exposure process may be performed by, for example, applying light having an intensity of about 10 milliwatts per square centimeter (mW/cm²) to about 100 mW/cm² at a wavelength of 365 nanometers (nm) or applying UV light having an energy greater than or equal to about 1 joule (J).

After the electric field applied to a liquid crystal panel 500-3 is released, the liquid crystal molecules 301 on the pretilt alignment stabilization layer 194-2 may be maintained in their pretilted state. On the other hand, the liquid crystal molecules 301 on the second vertical alignment layer 270′ may be aligned to be substantially vertical with respect to the opposite display panel SUB2′ when the electric field applied to the liquid crystal panel 500-3 is released. As a result, there may be a difference between the pretilt angle θ₁ of the liquid crystal molecules 301 on the pretilt alignment stabilization layer 194-2 and the pretilt angle 02 of the liquid crystal molecules 301 on the second vertical alignment layer 270′. Thus, the generation of texture due to a misalignment between an upper curved display panel and a lower curved display panel may be prevented or minimized. The upper curved display panel corresponds to the opposite display panel SUB2′, and the lower curved display panel corresponds to a display panel SUB1′.

Referring to FIGS. 3 and 10, a curved liquid crystal panel 500C may be fabricated by bending the liquid crystal panel 500-3. During the bending of the liquid crystal panel 500-3, one of the display panel SUB1′ or the display panel SUB2′ may be moved in a leftward direction D1 or a rightward direction D2 relative to the other display panel.

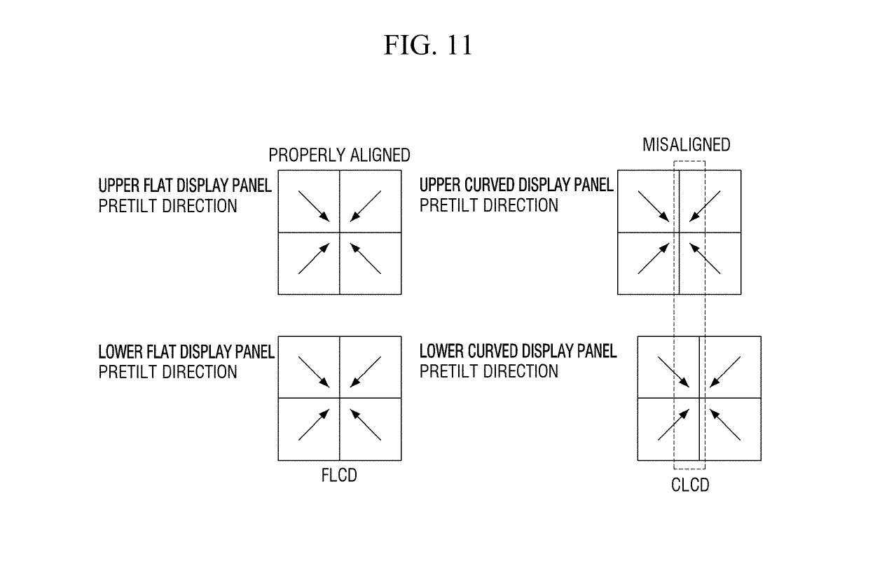

FIG. 11 illustrates states of alignment between an upper display panel and a lower display panel in a flat LCD (FLCD) and a curved LCD (CLCD) obtained from the FLCD, in which a pretilt alignment stabilization layer is formed on both upper and lower flat display panels.

The FLCD is a polymer stabilized alignment (PSA)- or polymer stabilized-vertical alignment (PS-VA)-mode FLCD in which a pretilt alignment stabilization layer is formed on both upper and lower flat display panels and liquid crystal molecules on the pretilt alignment stabilization layer have the same pretilt angle and form multiple domains.

Referring to FIG. 11, in a case in which the CLCD is obtained from the FLCD, a misalignment error may be generated between the upper and lower curved display panels. As a result, the alignment direction of liquid crystal molecules on the upper curved display panel and the alignment direction of liquid crystal molecules on the lower curved display panel may collide with each other, and liquid crystal molecules in the middle of the liquid crystal layer may be substantially vertically aligned so as to cause texture (in an area of the related-art CLCD enclosed by a dotted line) to be viewed as a smudge or a dark spot. Thus, the transmittance of the related-art CLCD is lowered.

However, the inventors have found a decrease of about 9% in luminance was detected in a CLCD in which the pretilt angle of liquid crystal molecules aligned on an upper flat display panel was the same as the pretilt angle of liquid crystal molecules aligned on a lower flat display panel. The inventors also unexpectedly discovered that the decrease in luminance, caused by a misalignment error between the upper curved display panel and the lower curved display panel, was reduced to about 1% when the difference between the pretilt angle of the liquid crystal molecules aligned on the upper flat display panel and the pretilt angle of the liquid crystal molecules aligned on the lower flat display panel was greater than or equal to about 0.8 degrees (°).

Table 1 shows experimental results obtained by measuring the degree of reduction in the luminance of a CLCD having a curvature radius of 4000 R while changing the difference between the pretilt angle of liquid crystal molecules on the upper flat display panel and the pretilt angle of liquid crystal molecules on the lower flat display panel.

TABLE 1

| Pretilt Angle (°) | | | Transmittance (a.u.) | | |
|---|---|---|---|---|---|
| Lower flat | Upper flat | Difference | When | When | |
| display | display | in pretilt | properly | misaligned | Luminance |
| panel | panel | angle | aligned | by 30 μm | Variation (%) |
| 89.0 | 90.0 | 1.0 | 0.17072 | 0.17072 | 0.0% |
| | 89.8 | 0.8 | 0.17191 | 0.16988 | −1.2% |
| | 89.5 | 0.5 | 0.17339 | 0.16651 | −4.0% |
| | 89.2 | 0.2 | 0.17459 | 0.16250 | −6.9% |
| | 89.0 | 0.0 | 0.17527 | 0.15955 | −9.0% |

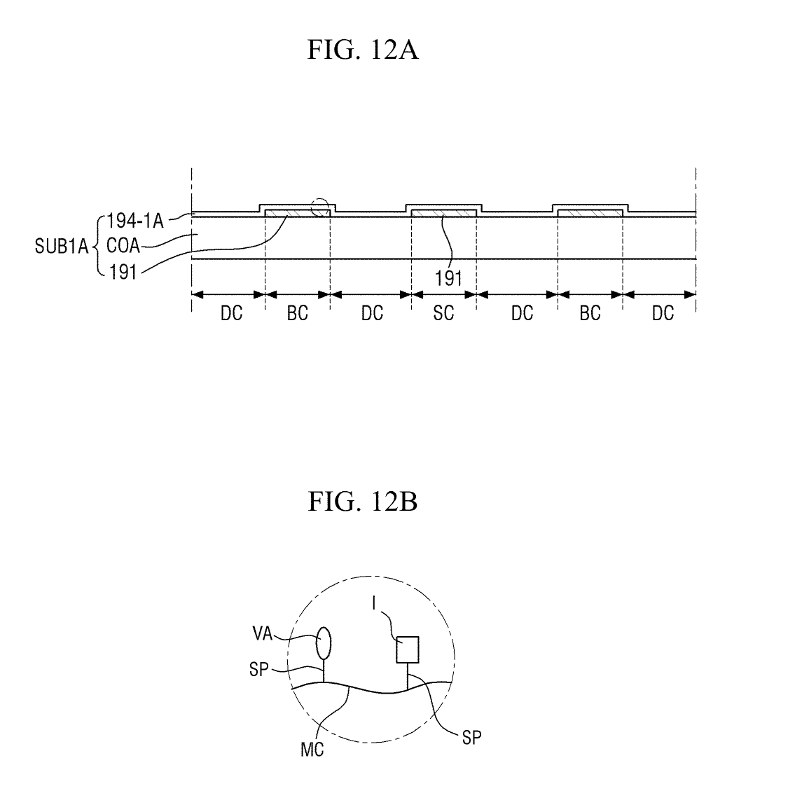

FIGS. 12A, 12B, 13A, 13B, 13C, 14A, 14B, and 15 are schematic views illustrating a method of manufacturing an LCD according to another exemplary embodiment of the present disclosure.

The exemplary embodiment of FIGS. 12A through 15 differs from the exemplary embodiment of FIGS. 5A through 10 in that a second polymerization initiator I is inactivated by rinsing the second pre-vertical-alignment layer 270A with a hydrogen peroxide solution. The exemplary embodiment of FIGS. 12A through 15 also differs from the exemplary embodiment of FIGS. 5A through 10 in that a liquid crystal layer 300 is formed using a liquid crystal composition which includes reactive mesogens RM.

FIG. 12A illustrates a method of fabricating a display panel SUB1A. FIG. 12B is an expanded view of the circled portion in FIG. 12A. Referring to FIGS. 12A and 12B, the display panel SUB1A may be fabricated by forming a pixel electrode 191 on a color filter on array substrate COA and forming a first pre-vertical-alignment layer 194-1A on the pixel electrode 191. The first pre-vertical-alignment layer 194-1A may comprise a branched polymer having a main chain MC, a first vertical alignment group VA, and a first polymerization initiator I, and the first vertical alignment group VA and the first polymerization initiator I may be bound (e.g. covalently attached) to the main chain MC via spacer groups SP. The first pre-vertical-alignment layer 194-1A may not include a reactive mesogen and a radical scavenger.

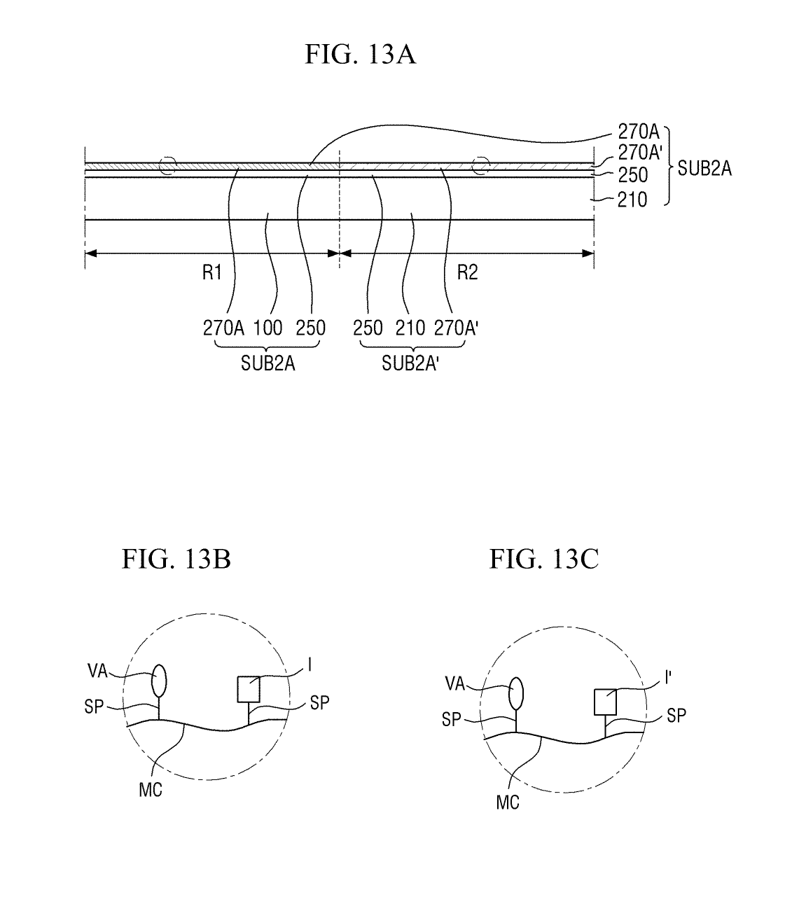

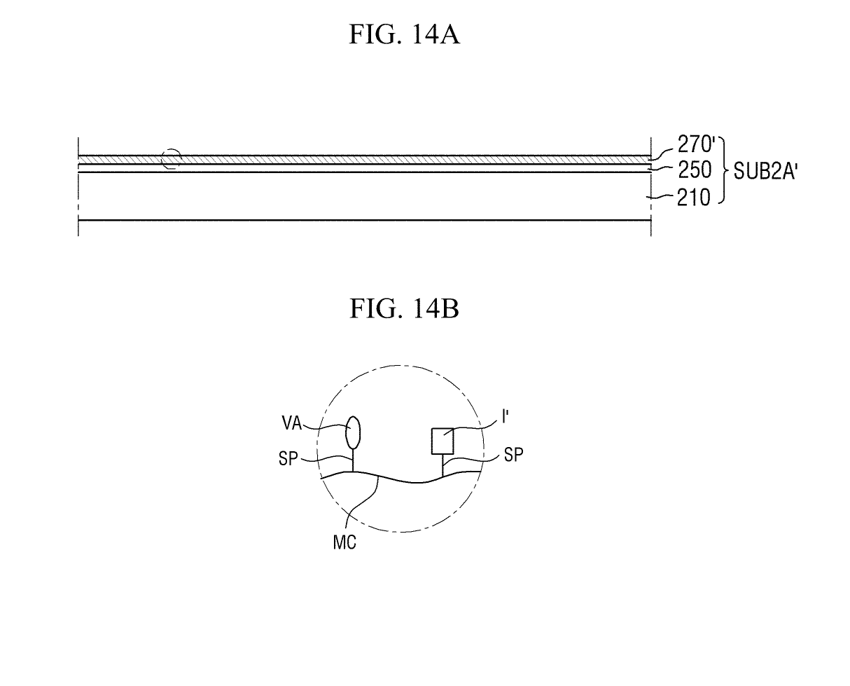

FIG. 13A illustrates rinsing an opposite display panel SUB2A with a hydrogen peroxide solution, and FIGS. 13B and 13C are enlarged views of the respective circled portions in FIG. 13A. FIG. 14A illustrates an opposite display panel SUB2A′ obtained by rinsing the opposite display panel SUB2A of FIG. 13A with a hydrogen peroxide solution, and FIG. 14B is an enlarged view of the circled portion of FIG. 14A.

Referring to FIGS. 13A, 13B, 14A, and 14B, the opposite display panel SUB2A may be fabricated by forming a common electrode 250 on a second base substrate 210, applying a second vertical alignment agent onto the common electrode 250, and performing thermal treatment so as to form a second pre-vertical-alignment layer 270A. The second pre-vertical-alignment layer 270A may comprise a branched polymer having a main chain MC, a second vertical alignment group VA, and a second polymerization initiator I. In an area R1 not rinsed with a hydrogen peroxide solution, the second polymerization initiator I is bound to the main chain MC via a spacer group SP (i.e. a “branch” of the branched polymer), and in an area R2 rinsed with a hydrogen peroxide solution, a decomposition product I′ of the second polymerization initiator I is bound to the main chain MC via a spacer group SP. Once the inactivation of the second polymerization initiator I using a hydrogen peroxide solution is complete, the opposite display panel SUB2A′ is formed. The opposite display panel SUB2A′ differs from the opposite display panel SUB2A of FIG. 13 in that a second pre-vertical-alignment layer 270A′, which includes the main chain MC, the second vertical alignment group VA, and the decomposition product I′ of the second polymerization initiator I, is formed on the common electrode 250.

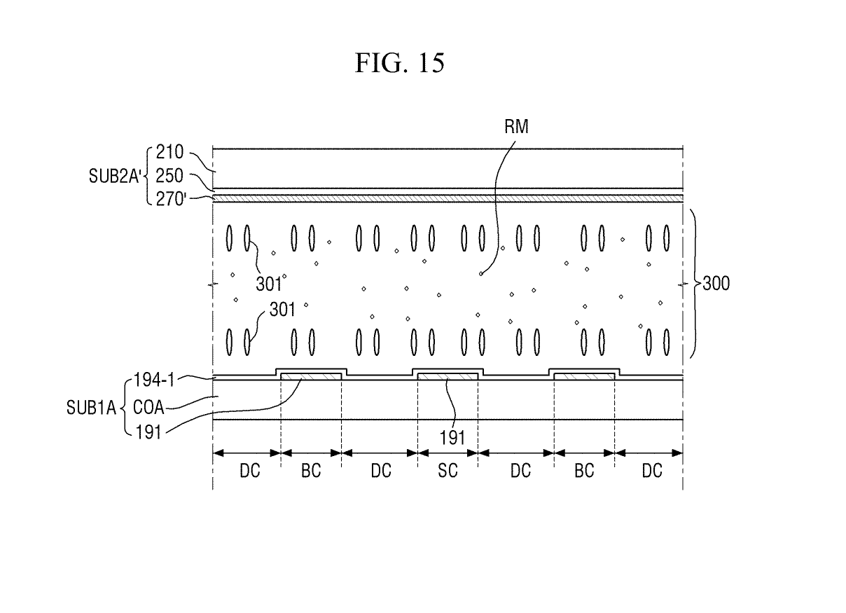

FIG. 15 illustrates forming a liquid crystal layer 300 between the display panel SUB1A and the opposite display panel SUB2A′ using a liquid crystal composition including the reactive mesogen RM and liquid crystal molecules 301. Processes subsequent to the formation of the liquid crystal layer 300 are identical to their respective counterparts of the exemplary embodiment of FIGS. 5A through 10, and detailed descriptions thereof are omitted.

In the exemplary embodiment of FIGS. 5A through 10, reactive mesogens are added to a liquid crystal alignment agent, whereas in the exemplary embodiment of FIGS. 12A through 15, the reactive mesogen is added to a liquid crystal composition, rather than to a liquid crystal alignment layer. However, the present disclosure is not limited to the exemplary embodiment of FIGS. 5A through 10 and to the exemplary embodiment of FIGS. 12A through 15. That is, a modification of the exemplary embodiment of FIGS. 5A through 10 in which the reactive mesogen is added to a liquid crystal composition, and a modification of the exemplary embodiment of FIGS. 12A through 15 in which the reactive mesogen is added to a liquid crystal alignment agent, are both within the scope of the present disclosure.

It will be apparent to those skilled in the art that various modifications and variation can be made in the described embodiments. The described embodiments cover modifications and variations within the scope defined by the appended claims and their equivalents.

What is claimed is:

1. A method of manufacturing a liquid crystal display, comprising:
forming a first pre-vertical alignment layer on a pattern electrode, the first pre-vertical alignment layer comprising a reactive mesogen and a first polymerization initiator;
forming a second pre-vertical alignment layer on a patternless electrode, the second pre-vertical alignment layer comprising a second polymerization initiator;
forming a second vertical alignment layer by inactivating the second polymerization initiator and not inactivating the first polymerization initiator, wherein the second vertical alignment layer comprises a decomposition product of the second polymerization initiator;
forming a liquid crystal layer between the first pre-vertical alignment layer and the second vertical-alignment layer, the liquid crystal layer comprising a liquid crystal composition having negative dielectric anisotropy;
eluting the reactive mesogen from the first pre-vertical alignment layer to the liquid crystal layer by applying a thermal treatment;
forming a first vertical alignment layer and a pretilt alignment stabilization layer through an electric field exposure process, wherein the first vertical alignment layer comprises a decomposition product of the first polymerization initiator and the pretilt alignment stabilization layer comprises a polymer of the reactive mesogen; and
fabricating a curved liquid crystal module after the forming the pretilt alignment stabilization layer such that a surface of the curved liquid crystal module which faces a viewer has a concave shaped curve.

2. The method of claim 1, wherein the inactivating of only the second polymerization initiator comprises applying ultraviolet light to the second pre-vertical-alignment layer and not applying ultraviolet light to the first pre-vertical-alignment layer.

3. The method of claim 2, wherein the second pre-vertical alignment layer further comprises a radical scavenger capable of eliminating free radicals.

4. The method of claim 1, wherein the inactivating of only the second polymerization initiator comprises rinsing the second pre-vertical-alignment layer with a hydrogen peroxide solution and not rising the first pre-vertical alignment layer with the hydrogen peroxide solution.

5. A method of manufacturing a liquid crystal display, comprising:
forming a first pre-vertical-alignment layer on a pattern electrode, the first pre-vertical alignment layer comprising a first polymerization initiator;
forming a second pre-vertical-alignment layer on a patternless electrode, the second pre-vertical alignment layer comprising a second polymerization initiator;
forming a second vertical alignment layer by inactivating the second polymerization initiator and not inactivating the first polymerization initiator, wherein the second vertical alignment layer comprises a decomposition product of the second polymerization initiator;
forming a liquid crystal layer between the first pre-vertical alignment layer and the second vertical-alignment layer, the liquid crystal layer comprising a liquid crystal composition having negative dielectric anisotropy;
forming a first vertical alignment layer and a pretilt alignment stabilization layer through an electric field exposure process, wherein the first vertical alignment layer comprises a decomposition product of the first polymerization initiator and the pretilt alignment stabilization layer comprises a polymer of the reactive mesogen; and
fabricating a curved liquid crystal module after the forming the pretilt alignment stabilization layer such that a surface of the curved liquid crystal module which faces a viewer has a concave shaped curve.

6. The method of claim 5, wherein the inactivating of only the second polymerization initiator comprises applying ultraviolet light to the second pre-vertical-alignment layer and not applying ultraviolet light to the first pre-vertical-alignment layer.

7. The method of claim 6, wherein the second pre-vertical-alignment layer further comprises a radical scavenger capable of eliminating free radicals.

8. The method of claim 5, wherein the inactivating of only the second polymerization initiator comprises rinsing the second pre-vertical-alignment layer with a hydrogen peroxide solution, and not rising the first pre-vertical-alignment layer with the hydrogen peroxide solution.
